(19) United States
(12) Patent Application Publication
(10) Pub. No.: US 2025/0198803 A1
(43) Pub. Date: Jun. 19, 2025

(54) ENCODER

(71) Applicant: Dyson Technology Limited, Malmesbury, Wiltshire (GB)

(72) Inventors: Miltiadis Alexios PAPADOPOULOS, Bristol (GB); Robert James Kenward MCDOUGALL, Swindon (GB)

(21) Appl. No.: 18/846,790

(22) PCT Filed: Mar. 2, 2023
(86) PCT No.: PCT/GB2023/050477

§ 371 Date: Sep. 13, 2024

(30) Foreign Application Priority Data
Mar. 14, 2022 (GB) 2203475.5

(51) Int. Cl. G01D 5/14; G01D 5/20; G01D 5/249

(52) U.S. Cl. CPC G01D 5/145; G01D 5/2006; G01D 5/2497; G01D 2205/775

(57) ABSTRACT

A hybrid encoder comprising an inductive encoder and a magnetic encoder. The inductive encoder comprises a metal target having a ramped width, an inductor coil configured to generate an oscillating electromagnetic field, and an inductive sensing circuit configured to detect a manipulation of the oscillating electromagnetic field as the inductor coil moves relative to the metal target in a direction perpendicular to the width of the metal target. The magnetic encoder comprises at least one multipole magnet, and a magnetic sensing circuit configured to detect a change in magnetic field as the magnetic sensing circuit moves relative to the at least one multipole magnet.

### FIELD OF THE INVENTION

The present invention relates to an encoder and particularly, although not exclusively, to a hybrid encoder comprising an inductive encoder and a magnetic encoder.

### BACKGROUND

Encoders are electro-mechanical devices that convert position into an analog or digital output signal. They can thus be used as position sensors. Angular encoders are a type of sensing device that detect rotation angle, and linear encoders are a type of sensing device that detect linear displacement.

Angular encoders are of particular importance in robotic applications, e.g. to determine the angular position of joints such as part of a robotic arm. In the case of a robotic arm, the angular encoder must be both accurate and absolute, in order to reduce the positioning error of the end effector and avoid initial position zeroing each time there is a reset.

In robotic applications, there is also a need for cabling to extend through the joint, and thus for angular encoders that can be fitted on articulated joints that allow for cabling to extend through the joint. Many conventional encoding solutions cannot be fitted in this manner.

One solution is to provide a low-profile magnetic encoder, such as the AksIM-2™ Off-Axis Rotary Absolute Magnetic Encoder Module, which is designed for applications with limited installation space. This non-contact encoder detects and evaluates the magnetic field of a thin, axially magnetized ring. The resolution offered by such encoders is approximately 20 bits for 360 degrees, which corresponds to an accuracy of 0.0003 degrees per bit. This level of accuracy is more than sufficient for use in robotic applications. However, these encoders are expensive to manufacture, and require tighter mounting tolerances in order to function than can conventionally be provided.

It is also known to use hybrid encoders which use both optical and magnetic components to provide position sensing (e.g. CN209279997U and WO2021017074A1). However, an issue with optical encoders is that dust accumulation can affect the sensor and its operation. For robotic applications, there is a need for the encoder to operate accurately in a contaminated environment.

The present invention has been devised in light of the above considerations.

### SUMMARY OF THE INVENTION

According to a first aspect of the invention there is provided a hybrid encoder comprising:
an inductive encoder, the inductive encoder comprising:
   a metal target having a ramped width;
   an inductor coil configured to generate an oscillating electromagnetic field; and
   an inductive sensing circuit configured to detect a manipulation of the electromagnetic field as the inductor coil moves relative to the metal target in a direction perpendicular to the width of the metal target; and
a magnetic encoder, the magnetic encoder comprising:
   at least one multipole magnet; and
   a magnetic sensing circuit configured to detect a change in magnetic field as the magnetic sensing circuit moves relative to the at least one multipole magnet.

By combining magnetic and inductive encoder technology, the hybrid encoder provides both absolute and relative positioning. In particular, the inductive encoder provides absolute positioning at a lower resolution, whereas the magnetic encoder provides relative positioning at a higher resolution. As such, even though the magnetic encoder may not be able to determine the absolute position, a lower resolution, approximate absolute position may be found using the inductive encoder, and the resolution of this absolute position can then be improved using the higher resolution relative position detected by the magnetic encoder.

This hybrid magnetic and inductive encoder also provides a non-contact solution, thus allowing for one or more cables to be passed through the joint, and also reducing wear on the moving parts. It can also operate in a contaminated environment, e.g. with dust, which is known to cause problems for other encoder technology, such as optical encoders.

Furthermore, although the resolution offered by this hybrid solution may be less than the resolution offered by other magnetic encoders such as the AksIM-2™ encoder, the resolution is still sufficient for the robotic applications, does not require as tight mounting tolerances, and is less expensive to manufacture. Optional features of the present invention will now be set out. These are applicable singly or in any combination with any aspect of the present disclosure.

The metal target having a ramped width may be considered to be a metal target having a width which changes along its longitudinal length.

Preferably, the metal target is mechanically coupled to the at least one multipole magnet. In this way, the passive target of both the inductive and magnetic encoders may be mechanically fixed in relation to one another. The inductor coil and/or the inductive sensing circuit may be mechanically coupled to the magnetic sensing circuit. As such, the sensing part of both the magnetic and inductive encoders may be mechanically fixed in relation to one another. This may help to ensure that the hybrid encoder remains calibrated over time.

The metal target and the at least one multipole magnet may be mounted on a first housing, and the inductor coil and the magnetic sensing circuit may be mounted on a second housing which is movable relative to the first housing. Optionally, the inductive sensing circuit may also be mounted on the second housing.

In this way, the passive components of the magnetic and inductive encoders are provided on a first part of the hybrid encoder, and the active components of the magnetic and inductive encoders are provided on a second part of the hybrid encoder. As such, no electrical connections are required to extend between the first and second housing parts in order for the hybrid encoder to function. This allows for a non-contact hybrid encoder, reducing wear of any moving parts of e.g. a joint upon which the hybrid encoder is mounted.

The hybrid encoder may comprise a processor. The processor may be configured to determine a position of the first housing relative to the second housing based on the manipulation of the electromagnetic field detected by the inductive sensing circuit, and the change in magnetic field detected by the magnetic sensing circuit.

As such, the relative position of the first and second housing may be determined by the hybrid encoder.

In particular, the processor may be configured to:
determine an absolute position of the first housing relative to the second housing based on the manipulation of the electromagnetic field detected by the inductive sensing circuit; and
determine a higher resolution relative position of the first housing relative to the second housing based on the determined absolute position of the first housing relative to the second housing, and the change in magnetic field detected by the magnetic sensing circuit.

The hybrid encoder may comprise at least one RLC oscillator circuit. The RLC oscillator component may comprise a resistor component, an inductor component, and a capacitor component. The resistor component may result from internal resistance of the oscillator circuit. Alternatively, it may be a discreet component, e.g. a discrete resistor. The inductor coil may form the inductor, L, component of the RLC oscillator circuit.

Preferably, the magnetic encoder may comprise a plurality of multipole magnets. This may increase the resolution of the relative positioning.

The inductive encoder may comprise a plurality of inductor coils. This may increase the accuracy of the absolute positioning.

The hybrid encoder may be an angular encoder. As such, the hybrid encoder may determine angular position, e.g. angular position of the first housing relative to the second housing. As such, when the first housing and second housing are mechanically fixed to two moving parts of a joint, the relative angular position of the two moving parts of the joint may be determined.

In examples where the hybrid encoder is an angular encoder, the metal target may be a ring-like crescent-shaped metal trace. As such, the ramped width of the metal target may be provided by a crescent shape. The metal trace may be a continuous trace (e.g. such that it never reaches a point with 0 width). Alternatively, the metal trace may not be continuous, e.g. the metal trace may have a point with 0 width. In some examples, the metal target may have the shape of a ring, wherein the point at which the width of the ring is largest opposes a point at which the width of the ring is narrowest, and wherein the metal target tapers from the point at which the width of the ring is largest to the point at which the width of the ring is narrowest.

In this way, the inductive encoder can provide 12 bits of absolute inductive based sensing of rotation, which corresponds to 0.09 degrees per bit of resolution.

The plurality of multipole magnets may be arranged in a ring-like configuration, e.g. on the first housing. They may be positioned inside the ring-like crescent-shaped metal trace.

In examples where the hybrid encoder is an angular encoder, the hybrid encoder may comprise at least two inductor coils configured to generate an oscillating electromagnetic field. The inductive sensing circuit may be configured to detect a manipulation of each oscillating electromagnetic field as the respective inductor coil moves relative to the metal target in a direction perpendicular to the width of the ring-like crescent-shaped metal trace.

The two inductor coils may be positioned such that an angle therebetween relative to a central axis of the ring-like crescent-shaped trace is less than 180°. Preferably, the angle between the two inductor coils relative to a central axis of the ring-like crescent-shaped trace may be between 45° and 135°, more preferably between 80° and 100°, more preferably approximately 90°. In particular, the inductive encoder can detect an absolute angular position using two inductor coils positioned at any angle other than at 180° from one another, although two inductor coils positioned at 90° from one another is most preferred.

The hybrid encoder may comprise four inductor coils. Each inductor coil may be configured to generate an oscillating electromagnetic field, wherein the inductive sensing circuit may be configured to detect a manipulation of each oscillating electromagnetic field as the respective inductor coil moves relative to the metal target in a direction perpendicular to the width of the metal target.

Providing four inductor coils/RLC circuits may provide improved redundancy and error correction in case of misalignment.

Preferably, the four inductor coils may be positioned e.g. on the second housing, such that the spacing between each inductor coil relative to a central axis of the ring-like crescent-shaped trace is approximately 90°. In other words, the four inductor coils may be equally spaced around a central point/axis of the ring-like crescent-shaped trace.

In other examples, the hybrid encoder may be a liner encoder. As such the hybrid encoder may determine linear displacement, e.g. linear position of the first housing relative to the second housing. As such, when the first housing and second housing are mechanically fixed to two moving parts, the relative linear position of the two moving parts may be determined.

In examples where the hybrid encode is a linear encoder, the metal target may be a ramped linear metal target. The plurality of multipole magnets may be positioned linearly, adjacent to the linear metal target along its longitudinal length. The inductive sensing circuit may be configured to detect a manipulation of the oscillating electromagnetic field as the inductor coil moves along the longitudinal length of the metal target.

The plurality of multipole magnets may comprise a plurality of pairs of dipole magnets arranged in alternating magnetic configuration. Other multipole magnets may also be used.

Preferably, the hybrid encoder comprises at least fifteen pairs of dipole magnets, more preferably at least twenty, more preferably at least thirty pairs of dipole magnets.

Increasing the number of pairs of magnets can provide a higher resolution. Nevertheless, this must be balanced with an available amount of space, e.g. at the joint upon which the hybrid encoder is to be positioned.

With thirty pairs of dipole magnets, the magnetic sensing circuit can sense thirty periods, and since the inductive encoder provides a resolution of 12 bits, the combination of the inductive and magnetic encoder provides a resolution of 0.003 degrees (360 degrees/30 pairs=12 degrees per pair, and 12 bits per pair=0.003 degrees per bit per pair).

In some examples, the inductor coil(s) may comprise a PCB (printed circuit board) coil.

In other examples, the inductor coil(s) may comprise a vertically stacked coil. In this way, the width footprint of the encoder may be reduced, without necessarily increasing the height footprint of the encoder, because this height space is already required by the plurality of magnets. In this way, the space required by the hybrid encoder is more efficiently used, resulting in a smaller hybrid encoder.

The metal target having a ramped width may comprise copper, for example. The at least one multipole magnet may comprise neodymium.

According to a second aspect, there is provided use of the hybrid encoder of the first aspect to determine an angular position of a robotic joint. The robotic joint may be part of a robotic arm, for example.

The invention includes the combination of the aspects and preferred features described except where such a combination is clearly impermissible or expressly avoided.

### SUMMARY OF THE FIGURES

Embodiments and experiments illustrating the principles of the invention will now be discussed with reference to the accompanying figures in which:

FIG. 1 is a schematic top view of a hybrid encoder;

FIG. 2 is a schematic partial side view of the hybrid encoder of FIG. 1;

FIG. 3a and FIG. 3b are perspective views of an example hybrid encoder;

FIG. 4 shows a first housing part of another example of a hybrid encoder; and

FIG. 5 shows a second housing part of the another example hybrid encoder.

### DETAILED DESCRIPTION OF THE INVENTION

Aspects and embodiments of the present invention will now be discussed with reference to the accompanying figures. Further aspects and embodiments will be apparent to those skilled in the art. All documents mentioned in this text are incorporated herein by reference.

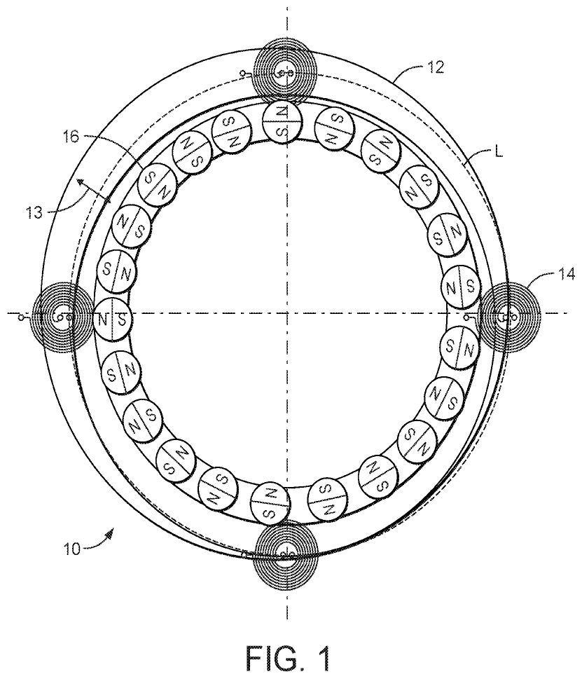

The layout of a hybrid encoder 10 is shown in FIG. 1, which is a schematic top view of the hybrid encoder. The hybrid encoder 10 combines both magnetic and inductive encoder technology, and thus comprises both a magnetic encoder and an inductive encoder in order to determine position. Using magnetic and inductive encoder technology results in a non-contact solution, such that wear is minimised. In the example hybrid encoder 10 shown in FIG. 1, the hybrid encoder is an angular encoder.

The hybrid encoder 10 comprises two tracks of encoding targets; an outer absolute positioning target, and an inner relative positioning target.

The outer absolute positioning target is the encoding target for the inductive encoder. It comprises a ring-like crescent-shaped metal trace 12. As shown in FIG. 1, the inductive metal trace 12 is a continuous crescent moon shaped, such that the width 13 of the inductive metal trace 12 is ramped along its length. The inductive metal trace 13 may comprise copper, for example.

The inductive encoder also comprises at least two inductor coils 14. In the example shown in FIG. 1, the inductive encoder comprises four inductor coils, although only two may be necessary in order for the inductive encoder to measure absolute angular position. Four inductor coils 14 are preferably used, as shown in FIG. 1, for redundancy and error correction in case of misalignment. In use, the inductor coils 14 are kept in oscillation such that they generate an oscillating electromagnetic field.

Although not shown in FIG. 1, an inductive sensing circuit is configured to detect a manipulation of the oscillating electromagnetic fields as the inductor coils 14 move relative to the inductive metal target 12 in a direction perpendicular to the width of the metal target. In particular, as the inductor coils 14 move relative to the inductive metal target 12 along line L, the resonant frequency of the inductor coils 14 changes due to the change in inductance as the width of the metal target 12 changes. This change in resonant frequency of the inductor coils 14 is measured by the inductive sensing circuit, which may be a circuit chip such as the LDC1614 chip from Texas Instruments. The inductor coils 14 may form RLC oscillator tanks, for example.

The crescent-shaped inductive metal target 12 offers 12 bits of absolute inductive based sensing or rotation, which corresponds to 0.09 degrees per bit of resolution, in the angular encoder 10.

The inner relative positioning target is the encoding target for the magnetic encoder. It comprises a plurality of magnetic dipole magnets 16 in an alternating configuration. As shown in FIG. 1, the magnetic dipole magnets 16 are positioned in a ring configuration within the ring-like crescent-shaped inductive metal target 12. The magnets may comprise rare earth metal magnets, for example.

Although not shown in FIG. 1, the magnetic inductor also comprises a magnetic sensing circuit configured to detect a change in magnetic field as the magnetic sensing circuit moves relative to the magnetic dipole magnets 16. In particular, the magnetic sensing circuit senses one period of alternating magnetic field for a pair of dipole magnets 16. A monolithic power Integrated Circuit (IC), such as the MA710, may be used as the magnetic sensing circuit. The magnetic dipole magnets 16 also offer 12 bits of resolution for a rotating diametrically magnetised target, because the sensor detects both poles of a magnet during a full rotation. This corresponds to 0.09 degrees of resolution.

By positioning the magnetic dipole magnets 16 next to the inductive metal target 12, the absolute positioning of the inductive metal target 12 can be combined with the quick response of the relative magnetic sensing circuit to an increased number of magnetic dipoles 16. As such, a plurality of magnetic dipole magnet pairs is preferably used. The limit on the number of magnetic dipole pairs employed may be the size of the hybrid encoder, which may be limited by the size of the structure (e.g. joint) upon which it is attached. There is also a certain point where the absolute inductive positioning will not have the necessary resolution to sync with the magnetic pairs. The present inventors have found that this point is at 400 magnetic pairs, with some headroom for positioning error on the inductive encoder side. A such, the magnetic encoder preferably comprises less than or equal to 400 magnetic dipole pairs.

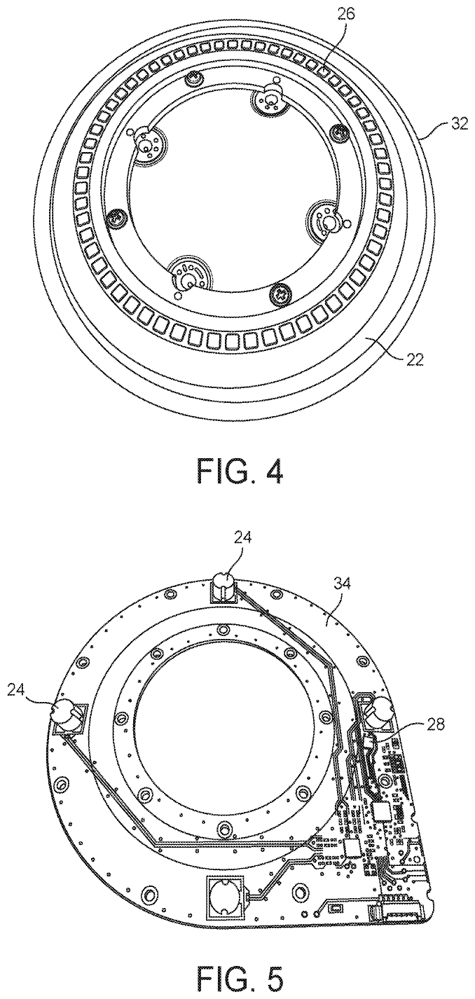

In the hybrid encoder shown in FIGS. 4 and 5, there are thirty magnetic dipole pairs used (see e.g. FIG. 4). This corresponds to sixty magnets 16 positioned in alternating polarity. The hybrid encoder now has 12 degrees of resolution allocated to each magnetic pair, which, together with the magnetic sensor resolution translates to 0.003 degrees of resolution. Changing the number of magnets allows for an adaptable and customizable resolution (e.g. the more dipole magnet pairs used, the greater the degrees of resolution of the hybrid encoder). The high accuracy of the relative positioning magnetic target is thus fused with the lower accuracy of the absolute positioning inductive target.

The inductor coils 14 may comprise PCB inductor coils. However, such PCB inductor coils generally require a custom PCB with tighter tolerances, and require relatively large inductor coils and an inductive metal target with an increased size.

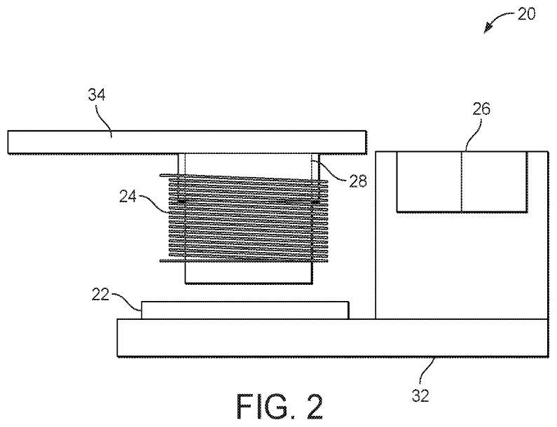

In order to alleviate this issue, the inductor coils 14 may instead be formed from Surface Mount Device (SMD) unshielded inductors 24, as shown in the side profile view of hybrid encoder 200 in FIG. 2. Hybrid encoder 20 is similar to hybrid encoder 10, bus has unshielded inductors 24 as the inductor coil.

The view of hybrid encoder 200 in FIG. 2 shows the relative positioning of inductive metal target 22, dipole magnet 26, unshielded inductor 24, and magnetic sensing chip 28. Although not shown in FIG. 2, the unshielded inductor 24 is electrically connected to an inductive sensing circuit, as described above.

Each unshielded inductor 24 comprises a vertically stacked coil. Such SMD unshielded inductors are readily available and thus do not require the manufacture of a custom PCB inductor coil. Furthermore, since the inductor coil is vertically stacked, the footprint of the hybrid encoder can be reduced (e.g. the width of the hybrid encoder). Although a greater vertical clearance is required, this space is not wasted as this vertical clearance is also required for the magnetic encoder (e.g. the magnetic sensing chip 28 and the dipole magnets 26), as shown in FIG. 2. Thus, a more compact hybrid encoder may be provided by using SMD unshielded inductors comprising vertically stacked coils.

As also shown in FIG. 2, the passive components of the magnetic encoder and inductive encoder are mounted on a separate housing to the active components. In particular, the inductive metal target 22 and the dipole magnets 26 are mounted on a first housing 32, and the unshielded inductor coil 24 and the magnetic sensing chip 28 are mounted on a second housing 34. The first housing 32 and the second housing 34 may be fixed to two parts of a joint for example, in order to determine the relative angular position of the two parts of the joint. The first housings 32 and the second housings 34 may be substrates, for example.

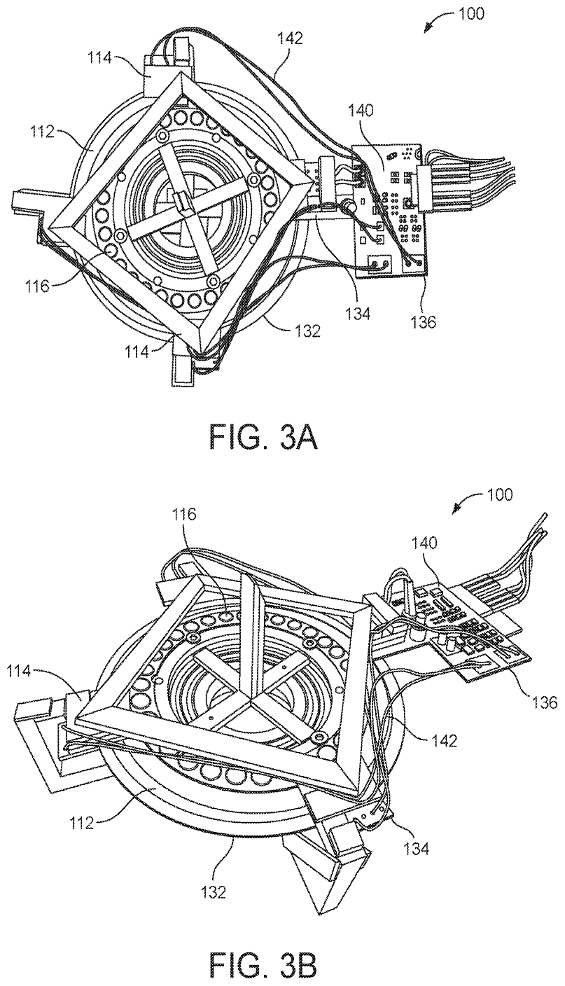

An implementation 100 of the hybrid encoder 10 is shown in FIGS. 3a and 3b. A first housing 132, formed from a PCB substrate, bears a crescent moon-shaped copper trace 112 that allows the inductive encoder to function. Within the inductive copper trace 112, there is a ring of diametrically magnetized neodymium magnets 116. In order to position these magnets 116 in a ring-like configuration such as that shown in FIGS. 3a and 3b, a hand-press was designed that allows the magnet to be levitated in a positioning tube between two further magnets. This may guarantee the polarity of the magnet. The magnet is then pressed and glued in place. Other manufacturing techniques may be used.

A second housing 134, formed from a PCB substrate, bears the four RLC tanks comprising the inductor coils 114, and the magnetic sensing chip (not shown in FIGS. 3a and 3b). The four RLC tanks are positioned above the copper trace 112, and are equally spaced about the copper trace ring such that an angle between each RLC tank is approximately 90 degrees.

The inductive sensing circuit 140 may be mounted on the second housing 134, or on a further substrate 136 as shown in FIGS. 3a and 3b. Wires 142 electrically connect each of the inductor coils 114 of the RLC tanks to the inductive sensing circuit 140.

The hybrid encoder shown in FIGS. 3a and 3b is mounted on a bearing to simulate a rotating joint. As best shown in FIG. 3a, the angle between the two inductor coils 114 relative to a central axis extending perpendicularly to the plane of the ring-like crescent-shaped trace and/or the ring of magnet pairs 116, is approximately 90°.

In other examples, there may only be two (or three) inductor coils. In examples with two inductor coils, the inductor coils are preferably positioned such that an angle therebetween relative to a central axis extending perpendicularly to the plane of the ring-like crescent-shaped trace and/or the ring of magnet pairs, is approximately 90%. However, angular position may still be determined with the two inductor coils positioned at any angle other than at 180° from one another.

The hybrid encoder also comprises a processor, which may be mounted on the second housing 134 or the further substrate 136, for example. The processor may be a Microcontroller unit (MCU), such as STM32F031K6 MCU. The processor is configured to determine a position of the first 132 housing relative to the second housing 134 based on the manipulation of the electromagnetic field detected by the inductive sensing circuit 140 and the change in magnetic field detected by the magnetic sensing circuit. In particular, the processor is configured to determine an absolute position of the first housing relative to the second housing based on the manipulation of the electromagnetic field detected by the inductive sensing circuit, and then determine a higher resolution relative position of the first housing relative to the second housing based on the determined absolute position of the first housing relative to the second housing, and the change in magnetic field detected by the magnetic sensing circuit. In this way, a mapping function may be used so that the microscopic magnetic location is combined with the macroscopic inductive location. The inductive encoder thus may be considered to allow self-calibration after production.

When there are thirty pairs of dipole magnets, each pair of magnets 116 represents 12 degrees of the 360 degree range. This means that when the hybrid encoder initializes, it will need to associate the sensed magnetic dipole to the specific 12 degree interval referenced by the absolute inductive encoder. As such, an initial factory calibration may be performed by rotating the encoder in a known manner. As the inductive trace 112 and magnets 116 are fixed relative to one another (e.g. by the first housing 132), there is less need for re-calibration beyond what is necessary for the inductive and/or magnetic encoders independently.

The processor may also be configured to filter signals from the inductive encoder and/or the magnetic encoder, and/or store the signals and data. The hybrid encoder may also comprise a communication interface, which may be controlled by the processor to output/transmit the determined angular position.

FIGS. 4 and 5 show an implementation of hybrid encoder 20. The first housing 32 may be a first substrate, as shown in FIG. 4, and the second housing 34 may be a second substrate, as shown in FIG. 5. The plurality of pairs of dipole magnets 26 are mounted in a ring-like configuration on the first substrate 32 within the crescent-shaped inductive copper target 22. The four RLC tanks 24 are mounted in a 90 degree configuration on the second substrate 34, such that they are equally spaced from a midpoint of the second substrate and equally spaced along a ring centred on that midpoint. The magnetic sensing circuit 28 is positioned on the second substrate 34, adjacent to one of the RLC tanks 24 (at an angle of 10 degrees).

In the implementation shown in FIG. 5, unshielded power choke (e.g. vertically stacked inductor coils) provide the L component of the RLC tank. As described above, this may decrease the width footprint of the hybrid encoder.

The hybrid encoder shown in FIG. 4 comprises square magnets, although circular magnets and other shaped magnets may be used.

Although the figures described herein show angular encoders, the hybrid encoder may be a linear encoder. In these examples, the crescent-shaped metal target may have a ramped linear shape (e.g. similar to a right-angled triangle). The plurality of magnet pairs may be positioned linearly, adjacent to the metal target along its longitudinal length.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described.

Throughout this specification, including the claims which follow, unless the context requires otherwise, the word “comprise” and “include”, and variations such as “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means for example +/−10%.

1. A hybrid encoder comprising:
an inductive encoder, the inductive encoder comprising:
a metal target having a ramped width;
an inductor coil configured to generate an oscillating electromagnetic field; and
an inductive sensing circuit configured to detect a manipulation of the oscillating electromagnetic field as the inductor coil moves relative to the metal target in a direction perpendicular to the width of the metal target; and
a magnetic encoder, the magnetic encoder comprising:
at least one multipole magnet; and
a magnetic sensing circuit configured to detect a change in magnetic field as the magnetic sensing circuit moves relative to the at least one multipole magnet.

2. The hybrid encoder of claim 1, wherein the metal target is mechanically coupled to the at least one multipole magnet.

3. The hybrid encoder of claim 1, wherein:
the metal target and the at least one multipole magnet are mounted on a first housing; and
the inductor coil and the magnetic sensing circuit are mounted on a second housing which is movable relative to the first housing.

4. The hybrid encoder of claim 3, further comprising a processor, wherein the processor is configured to determine a position of the first housing relative to the second housing based on:
the manipulation of the oscillating electromagnetic field detected by the inductive sensing circuit; and
the change in the oscillating magnetic field detected by the magnetic sensing circuit.

5. The hybrid encoder of claim 4, wherein the processor is configured to:
determine an absolute position of the first housing relative to the second housing based on the manipulation of the oscillating electromagnetic field detected by the inductive sensing circuit; and
determine a higher resolution relative position of the first housing relative to the second housing based on the determined absolute position of the first housing relative to the second housing, and the change in the oscillating magnetic field detected by the magnetic sensing circuit.

6. The hybrid encoder of claim 1, comprising an RLC oscillator circuit comprising a resistor component, an inductor component, and a capacitor component, wherein the inductor coil forms the inductor, L, component of the RLC oscillator circuit.

7. The hybrid encoder of claim 1, wherein the hybrid encoder is an angular encoder.

8. The hybrid encoder of claim 7, wherein the metal target is a ring-like crescent-shaped metal trace.

9. The hybrid encoder of claim 8, wherein the magnetic encoder comprises a plurality of multipole magnets and the plurality of multipole magnets are arranged in a ring-like configuration inside the ring-like crescent-shaped metal trace.

10. The hybrid encoder of claim 8, comprising two inductor coils, each inductor coil configured to generate an oscillating electromagnetic field, wherein the inductive sensing circuit is configured to detect a manipulation of each electromagnetic field as the respective inductor coil moves relative to the metal target in a direction perpendicular to the width of the ring-like crescent-shaped metal trace, and wherein:
the two inductor coils are positioned such that an angle therebetween relative to a central axis of the ring-like crescent-shape trace, is less than 180 degrees.

11. The hybrid encoder of claim 7, comprising four inductor coils, each inductor coil configured to generate an oscillating electromagnetic field, wherein the inductive sensing circuit is configured to detect a manipulation of each electromagnetic field as the respective inductor coil moves relative to the metal target in a direction perpendicular to the width of the metal target.

12. The hybrid encoder of claim 1, wherein the hybrid encoder is a linear encoder.

13. The hybrid encoder of claim 1, wherein the magnetic encoder comprises a plurality of pairs of dipole magnets arranged in an alternating magnetic configuration.

14. The hybrid encoder of claim 13, comprising at least thirty pairs of dipole magnets.

15. The hybrid encoder of claim 1, wherein the inductor coil comprises a vertically stacked coil.
